(19) United States
(12) Patent Application Publication
(10) Pub. No.: US 2008/0134754 A1
(43) Pub. Date: Jun. 12, 2008

(54) Process for converting biogas to a pipeline grade renewable natural gas

(76) Inventor: Michael N. Funk, (US)

Correspondence Address: FROST BROWN TODD, LLC, 2200 PNC CENTER, 201 E. FIFTH STREET, CINCINNATI, OH, 45202, US

(21) Appl. No.: 12/001,322

(22) Filed: Dec. 11, 2007

Related U.S. Application Data
(60) Provisional application No. 60/874,120, filed on Dec. 11, 2006.

(51) Int. Cl. G01N 30/04; B01D 46/46; B01D 53/14

(52) U.S. Cl. 73/23.41; 95/15

(57) ABSTRACT

A process purifies raw biogas created from a renewable source into pipeline grade natural gas and/or D.O.T. specification, or other predetermined specification, gas. The automated scrubbing processed employed and the particular attributes of the system allow the system to function under extreme weather conditions by employing specific tools to control the temperature of the scrubbing water to allow for efficient and effective removal of the carbon dioxide gas. The system also employs specific measures to use recycled scrubbing water, thus eliminating the need for excessive water generally needed to economically employ this type of scrubbing process. The recycled water is continuously de-carbonated to allow the recycled water stream to effectively scrub the raw biogas. Treated gas from the process is then dried, and compressed for introduction into storage tanks or a natural gas pipeline delivery system.

This application claims the benefit of U.S. Provisional Application No. 60/874,120, entitled Process for Converting Biogas to a Pipeline Grade Renewable Natural Gas, filed Dec. 11, 2006.

### BACKGROUND OF THE INVENTION

The present invention relates in general to employing all of the necessary elements into a scrubbing process that will allow for the economic optimization of producing pipeline grade methane or a gas that meets D.O.T. specification, for example, from biogas.

Biogas can be derived from a number of different sources. The predominate sources of economically viable streams of biogas are generally produced through anaerobic digestion. Anaerobic digestion can occur naturally in landfills or in controlled environments that enhance the biological degradation of sewage waste, foodstuff waste, and animal waste.

Biogas in general is a low Btu gas that is contaminated with hydrogen sulfide and carbon dioxide. The gas is also highly saturated with water.

Based upon the increased value of all energy products and the drive for renewable and distributed sources of energy, the invention can be deployed nearly anywhere in the country where an economically viable biogas waste stream exists.

In general, the waste streams that are used in the anaerobic digestion process that converts waste to energy are a nuisance in their unaltered state. Anaerobic digestion in general converts waste streams to safer more useful products through the destruction of pathogens and the conversions of organic nutrients to inorganic nutrients in animal waste.

The general purpose for purifying the methane is to clean the product to the point where it meets pipeline grade natural gas specifications and/or D.O.T. or other specifications and can, therefore, be directly injected into a pipeline carrying natural gas or transported to a pipeline injection point.

It is known that carbon dioxide and hydrogen sulfide can be absorbed from methane by passing the stream containing the three gases countercurrent to water. The water absorbs the carbon dioxide and the hydrogen sulfide. The effectiveness of the process is based upon three key elements: gas pressure, water volume and contact time of the water and gas. Wide ranges of these variables have been employed to absorb carbon dioxide and hydrogen sulfide from methane.

The objective of the inventor is to optimize the economics of scrubbing gas when considering water to be a valuable resource. Many of the biogas waste streams that could potentially be purified are in areas that water is a valuable commodity. Thus, the driving factor of water preservation has caused the inventor to create a system for recycling scrubbing water that can be employed under most environmental conditions.

As described earlier, the keys to successful scrubbing are contact time, water volume and gas pressure. When considering 100% recycling of water additional factors play a role in scrubbing efficiency and effectiveness. They are water temperature (as noted by Henry's Law) and carbon dioxide saturation levels in the recycled water stream.

In order to minimize water flows and gas pressures the scrubbing process emphasize controlling scrubbing water temperature and the carbon dioxide saturation level of the scrubbing water. Through employing the simple measures of controlling water temperature and carbon dioxide saturation levels, the scrubbing process can effectively clean biogas to pipeline grade methane gas with 100% recycled water. The effect of controlling these two critical factors of scrubbing efficiency and effectiveness also allow the system to conserve energy through pumping lower water volumes and pressurizing gas less than has generally been employed by other technologies that scrub gas in this general fashion.

### BRIEF SUMMARY OF THE INVENTION

The invention provides a method of purifying low pressure biogas streams to pipeline grade methane or D.O.T. specification, or other predetermined specification, gas. The scrubbing methodology employed is unique due to the system's ability to recycle the scrubbing water and be deployed in areas where extreme weather conditions and restricted water availability do not alter the system's ability to produce a specified gas. Through controlling the scrubbing water temperature, the system is able to minimize biogas pressures and water flows generally employed by other scrubbing systems.

All purification and moisture parameters required by the gas specifications are programmed into the gas chromatograph which controls the valve that allows the gas to be injected into the pipeline or tanker truck. If biogas does not meet specification it is returned to the front of the scrubbing process for further purification. In the final step, the system compresses the gas to meet a preprogrammed pressure that will allow the gas to be injected into a pipeline or tanker.

In one embodiment of the present invention, an automated process of removing contaminants from a low pressure biogas stream and converting the biogas to pipeline grade methane or other specification gas comprises the following steps:
i. Remove substantially all of the hydrogen sulfide from the biogas stream under low pressure by allowing the hydrogen sulfide to be oxidized in an iron sponge reaction vessel.
ii. Elevate the pressure of the gas to the point where it can be compressed to an adequate pressure where it can be effectively scrubbed of other impurities.
iii. Allow pressurized gas to enter into a series of scrubbing towers containing packing that allows for the uniform dispersion of the gas as it migrates vertically from the bottom of the scrubbing vessel to the top of the scrubbing vessel. Scrubbing tower size is predicated by the actual quantity of gas being scrubbed.
iv. Force water through an opening at the top of the scrubbing towers in adequate quantity to allow for uniform dispersion through the packing, thus contacting the biogas as it is forced from the bottom of the vessels to the top.
v. Through controlling the quantity of water in gallons per minute and the pressure of the biogas, the biogas is allowed adequate contact time with the water to cause the carbon dioxide to become absorbed in the water. This scrubbing process can be accomplished at different volumes of water and different pressures. They key to economic optimization is derived at the lowest possible pressures and the lowest possible volume of water needed to remove the impurities from the gas. The only ways to accomplish these economies when recycling water are to de-carbonate the water and control the water temperature. Henry's Law dictates that the solubility of gases is decreasing with increasing water temperatures. Thus, without controlling the water temperature, economic optimization cannot be achieved.
vi. As the water is recycled it first goes into an in-ground de-carbonization tank. The water is forced through a spray bar that is located above the packing. The spray bar helps achieve de-carbonization by reducing water droplet size and evenly distributing the water over the packing while air is being forced up through the packing to help release the absorbed carbon dioxide.
vii. The scrubbing water then enters a holding tank where the temperature is monitored. As the water leaves the holding tank the temperature is controlled with a chiller and plate heat exchanger. Through control of the water temperature, one is able to minimize the volume of water and the pressure level of the gas entering the scrubbing tanks, thus, optimizing the economics of cleaning gas under the principles of Henry's Law.
viii. As the cleaned methane leaves the top of the last scrubbing tower, it is dried and then its quality is monitored by an in-line gas chromatograph. The gas chromatograph controls a two way valve that diverts biogas that meets pipeline specifications to the final compression stage and diverts out of specification gas back to the beginning of the scrubbing process.
ix. Gas that meets pipeline specifications is then dried and compressed to the pressure necessary for introduction into a tanker or a natural gas pipeline.

### BRIEF DESCRIPTION OF THE DRAWING

FIG. 1 is a process flow diagram of an embodiment of the overall process of the present invention.

FIG. 2 is an enlarged process flow diagram of a hydrogen sulfide removal portion of the process shown in FIG. 1.

FIG. 3 is an enlarged process flow diagram of a biogas compression recirculation header portion of the process shown in FIG. 1.

FIG. 4 is an enlarged process flow diagram of a scrubbing tower's portion of the process shown in FIG. 1.

FIG. 5 is an enlarged process flow diagram of a scrubbing water de-carbonation system and flash tank portion of the process shown in FIG. 1.

FIG. 6 is an enlarged process flow diagram of a scrubbing water storage and cooling portion of the process shown in FIG. 1.

FIG. 7 is an enlarged process flow diagram of a drying and final compression portion of the process shown in FIG. 1.

### DETAILED DESCRIPTION OF AN EMBODIMENT OF THE INVENTION

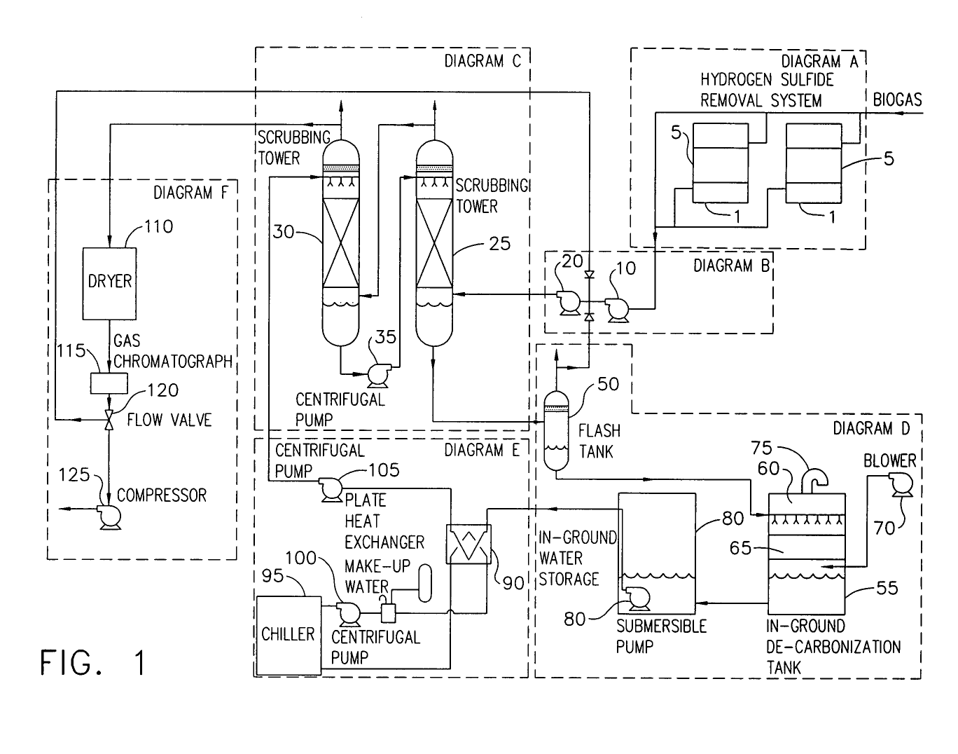

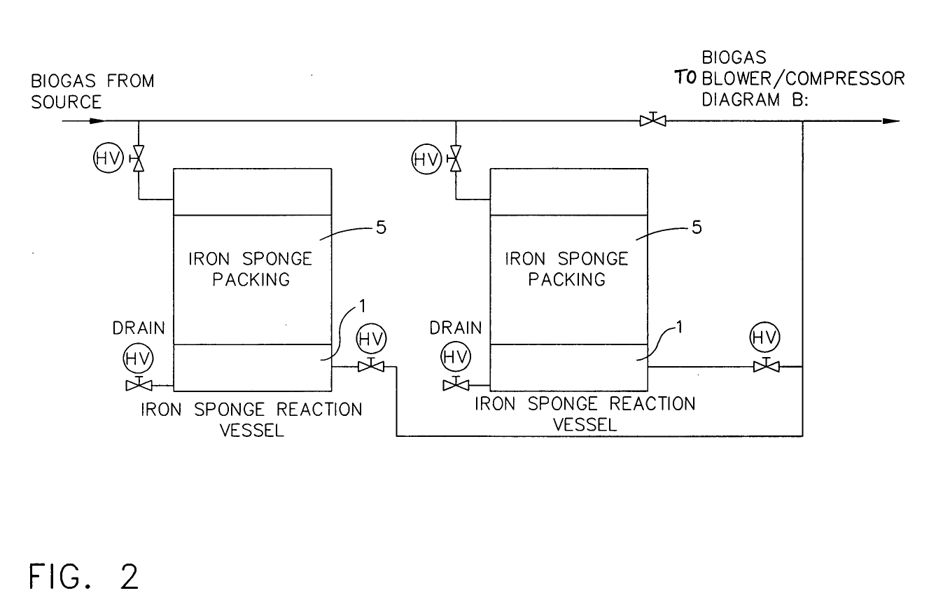

An embodiment of the present invention, depicted in FIG. 1, will be described below in further detail by reviewing each of the individual portions of that embodiment, depicted in FIGS. 2-7.

Diagram A: Dual Iron Sponge Reaction Vessels

As shown in FIG. 2, the dual iron sponge vessels (1) are used to remove the hydrogen sulfide prior to the biogas entering the absorption scrubbing process. Duplicity is not necessary but allows for the recharging of one unit while the other continues to remove hydrogen sulfide. Only one unit is active at all times. The low pressure gas stream from the anaerobic digestion source is pulled through the iron sponge vessel by fan (10). As the gas migrates down through the iron sponge vessel, the hydrogen sulfide comes into contact with iron oxide impregnated wood chips that make up the iron sponge packing (5). As the hydrogen sulfide comes into contact with the iron oxide, the reaction produces iron sulfide and water which remains in the Iron Sponge vessel (1). The gas is now free of hydrogen sulfide and is pulled to Diagram B by fan (10).

Diagram B: Biogas Compression and Recirculation Header

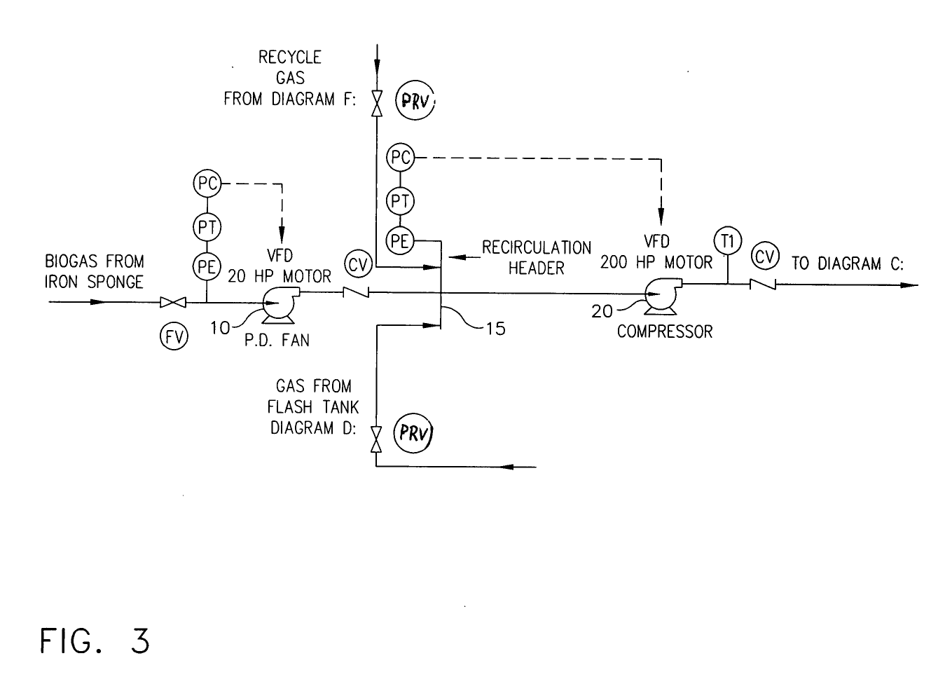

As shown in FIG. 3, fan (10) which is driven by a motor that is controlled by a variable frequency drive (VFD) is used to elevate the pressure of the gas from the source to allow for the proper feeding of compressor (20). The VFD motor on fan (10) allows for optimization based upon the availability of biogas from the source. Recirculation header (15) allows for the reintroduction of biogas that did not meet specification at the gas chromatograph (115) and the reintroduction of biogas that was recovered in the flash tank (50). The motor on compressor (20) is also controlled by a VFD which allows for optimization based upon available gas and desired pressure of the gas being delivered to Diagram C scrubbing tower (25).

Diagram C: Scrubbing Towers—Water & Gas Flow/Control

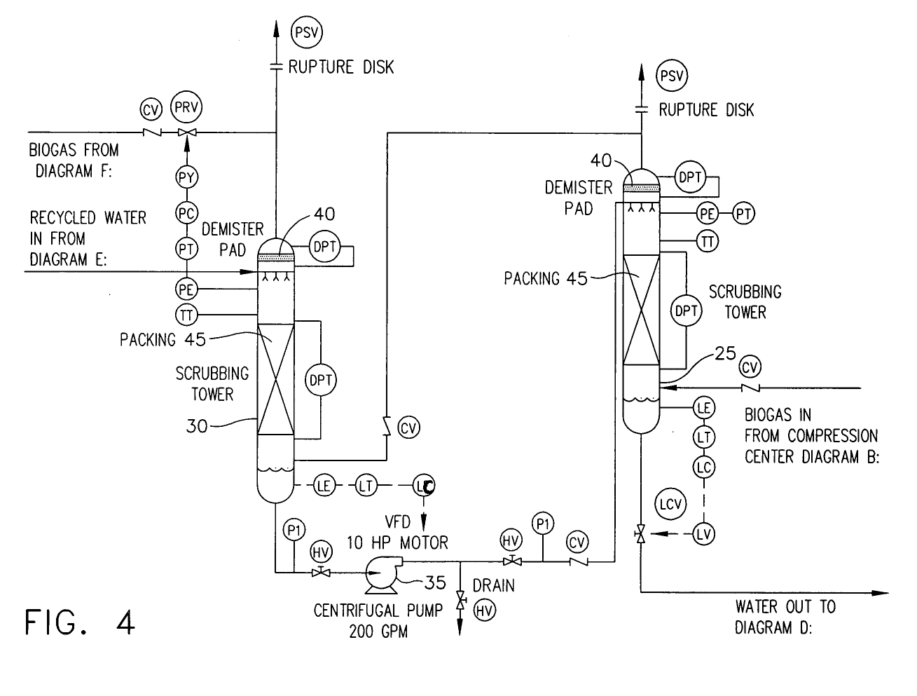

As depicted in FIG. 4, the scrubbing process takes place in dual scrubbing towers (25) and (30). The scrubbing towers (25) and (30) are identical with the exception of specific control functions. Each tower has a demister pad (40) and a set amount of packing (45) that causes even distribution of biogas and water as they flow in a countercurrent fashion through the towers (25) and (30). The biogas first enters at the bottom of tower (25) and flows out the top of tower (25) to enter in the bottom of tower (30) and then out the top of tower (30). The water is first introduced into tower (30) and exits the bottom of tower (30). Centrifugal pump (35), which is controlled by a VFD motor for optimization, assures that water is delivered to the top of tower (25) at a predetermined flow rate in gallons per minute (GPM). The water then exits at the bottom of tower (25). The countercurrent flow of clean water and raw biogas is optimized through the dual tower set-up. The raw gas enters tower (25) and is scrubbed with water from tower (30). As the partially cleaned biogas leaves tower (25) and enters tower (30) it is scrubbed by water that has been de-carbonated and chilled for optimum scrubbing. Tower (30) is the finishing tower in the purification process. As the biogas exits the top of tower (30) it is sent to Diagram F for final drying and compression. As the water exits the bottom of tower (25) it flows to Diagram D and enters flash tank (50).

This scrubbing process can be accomplished at different volumes of water and different pressures. It is preferable for economic optimization to use the lowest possible pressures and the lowest possible volume of water needed to remove the impurities from the gas. These economies can be achieved when recycling water by de-carbonating the water and/or by controlling the water temperature. Henry's Law dictates that the solubility of gases decreases with increasing water temperature. Therefore, it is preferable to control the water temperature for economic operation of the system.

Diagram D: Scrubbing Water De-carbonation System & Flash Tank

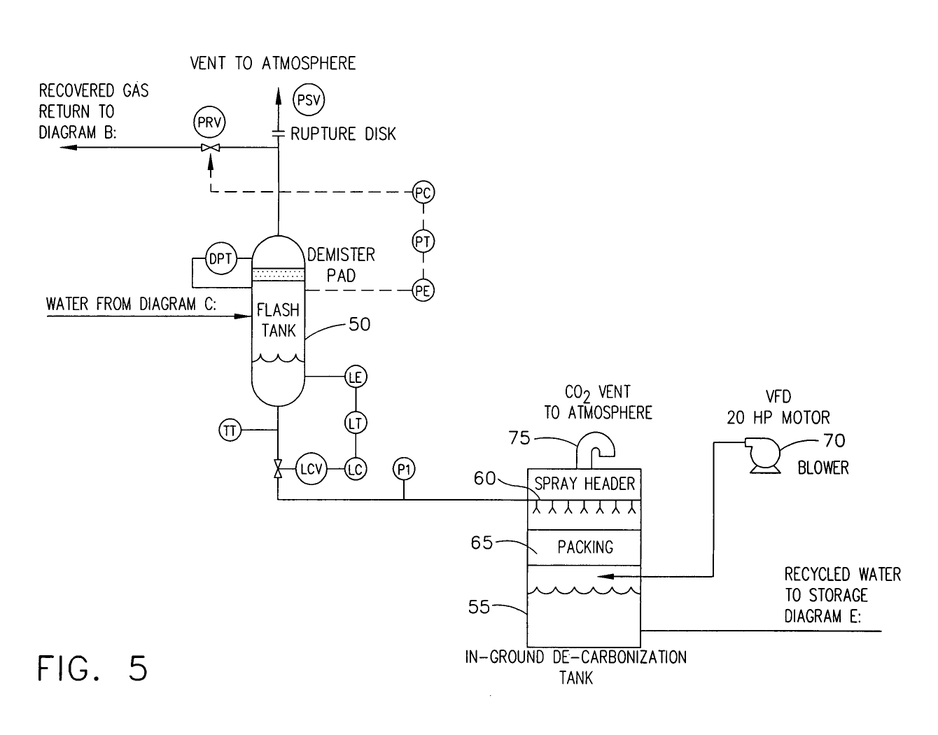

As shown in FIG. 5, the water first enters flash tank (50) where pressure is reduced rapidly to allow the residual methane to flash separate and return to the recirculation header (15) in Diagram B. The carbon dioxide rich water is then directed to the in-ground de-carbonization tank (55) where the water is evenly sprayed over the packing (65) by a spray header (60). The spray header (60) minimizes the droplet size to maximize the de-carbonation process. The spray bar helps achieve de-carbonization by reducing water droplet size and evenly distributing the water over the packing while air is being forced up through the packing to help release the absorbed carbon dioxide. As the small droplets migrate through the packing, air is forced in a countercurrent fashion from the bottom of the packing by blower (70), which is controlled by a VFD motor for optimization. The large quantity of air that is forced through the packing ensures the removal of the carbon dioxide from the recycle scrubbing water. The carbon dioxide is then vented to atmosphere through vent (75). When economical, the carbon dioxide will be captured and processed for commercial use. As the water exits the de-carbonization tank it flows to Diagram E and enters the in-ground water storage tank (80).

Diagram E: Scrubbing Water Storage & Cooling

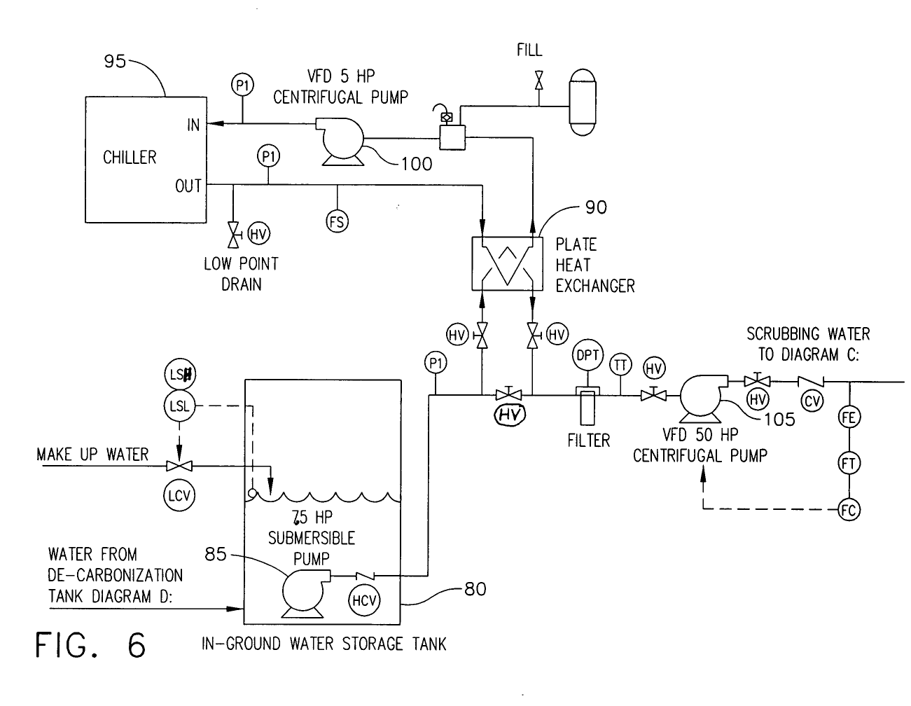

As shown in FIG. 6, the de-carbonated water flows into the in-ground storage tank (80) where it is picked up by submersible pump (85). Pump (85) circulates water to plate heat exchanger (90) where the water is cooled to a temperature that allows for the most efficient scrubbing (absorption) in towers (25) and (30). Through control of the water temperature the volume of water and the pressure level of the gas entering the scrubbing tanks is minimized, thus, optimizing the economics of cleaning gas under the principles of Henry's Law.

On the control side of the plate heat exchanger (90) centrifugal pump (100), which is controlled by a VFD motor for optimization, circulates water through chiller (95). Chiller (95) is controlled by the temperature sensor on the water line as the water exits flash tank (50). The temperature-controlled water leaving the plate heat exchanger (90) is picked up by centrifugal pump (105), which is controlled by a VFD motor for optimization, and elevated to the desired flow rate for entering tower (30).

Diagram F: Drying and Final Compression

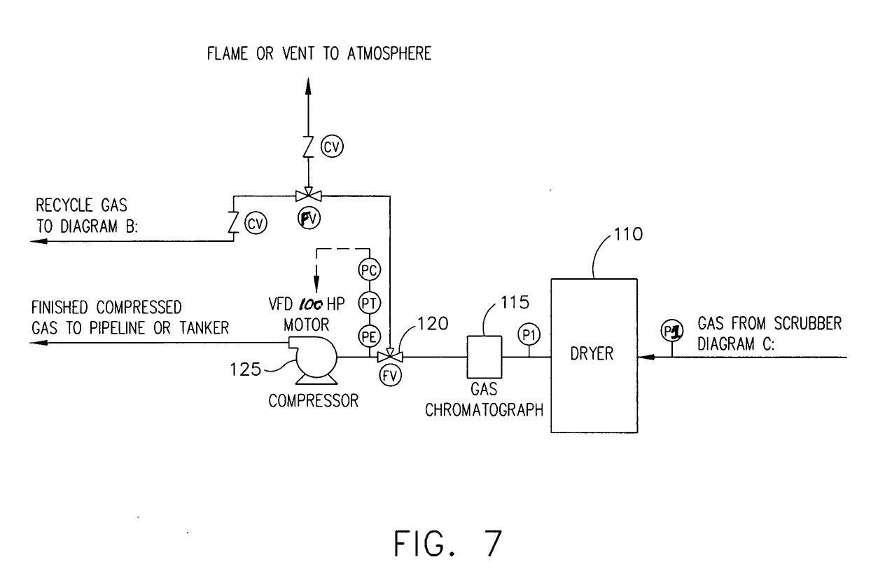

As shown in FIG. 7, as the biogas leaves tower (30) it flows to dryer (110). Dryer (110) dries the biogas to a pre-specified moisture content determined by the specification. As the gas leaves dryer (110), it flows to the gas chromatograph (115). Gas chromatograph (115) analyzes the gas quality to determine if the gas meets the preprogrammed specifications. If the gas meets the preprogrammed specifications, valve (120) directs the gas to compressor (125), which is controlled by a VFD motor for optimization, for pressurizing the gas to a preprogrammed pressure which allows the gas to either flow into a pipeline or tanker for delivery to the end user. If the gas does not meet the preprogrammed specifications, valve (120) opens the recycle line and allows the gas to return the recirculation header (15) for further scrubbing.

What is claimed is:

1. A process of converting biogas to pipeline grade methane comprising the steps of:
removing hydrogen sulfide from the biogas;
pressurizing the biogas;
scrubbing the biogas with water;
drying the biogas;
analyzing the biogas to determine whether it meets a preprogrammed specification; and
recycling any biogas that does not meet the preprogrammed specification.

2. The process of claim 1 wherein the hydrogen sulfide is removed from the biogas by use of a dual sponge vessel.

3. The process of claim 2 wherein the dual sponge vessel is packed with iron oxide impregnated wood chips.

4. The process of claim 1 wherein the biogas is pressurized by a variable frequency drive motor.

5. The process of claim 1 wherein the biogas is scrubbed using dual scrubbing towers.

6. The process of claim 1 wherein the biogas is scrubbed using a scrubbing tower comprising a demister pad.

7. The process of claim 1 wherein the biogas is scrubbed by at least one scrubbing tower wherein the biogas enters the tower from the bottom of the scrubbing tower and the water enters the scrubbing tower from the top of the scrubbing tower.

8. The process of claim 8 wherein the water is decarbonated.

9. The process of claim 8 wherein the water is chilled.

10. The process of claim 8 wherein the water enters a flash tank wherein the pressure is reduced rapidly after it exits the scrubbing tower.

11. The process of claim 8 further comprising the step of spraying the water over a packing after it exits the scrubbing tower.

12. The process of claim 12 further comprising the step of passing a large quantity of air through the packing.

13. The process of claim 8 further comprising the step of cooling the water after it exits the scrubbing tower,

14. The process of claim 14 wherein the water is cooled by a plate heat exchanger.

15. The process of claim 1 wherein the biogas is dried to a pre-specified moisture content.

16. The process of claim 1 wherein the biogas is analyzed by gas chromatograph after the drying step.

17. The process of claim 1 wherein the biogas that meets the preprogrammed specification is pressurized for delivery to the end user.

18. An automated process of converting biogas to pipeline grade methane comprising the steps of:
removing substantially all of the hydrogen sulfide from the biogas stream under low pressure by allowing the hydrogen sulfide to be oxidized in an iron sponge reaction vessel;
elevating the pressure of the gas to the point were it can be compressed to an adequate pressure where it can be effectively scrubbed of other impurities;
allowing pressurized gas to enter into a series of scrubbing towers, scrubbing tower size is predicated by the actual quantity of gas being scrubbed, containing packing that allows for the uniform dispersion of the gas as it migrates vertically from the bottom of the scrubbing vessel to the top of the scrubbing vessel;
forcing water through a spray bar at the top of the scrubbing towers in adequate quantity to allow for uniform dispersion through the packing, thus contacting the biogas as it is forced from the bottom of the vessels to the top;
wherein by controlling the quantity of water and the pressure of the biogas, the biogas is allowed adequate contact time with the water to cause the carbon dioxide to become absorbed in the water;
monitoring the scrubbing water temperature in a holding tank;
controlling the water temperature with a chiller and plate heat exchanger As the water leaves the holding tank the temperature is controlled with a chiller and plate heat exchanger;
drying the cleaned biogas;
monitoring the quality of the cleaned biogas with an in-line gas chromatograph;
diverting cleaned biogas that meets pipeline specifications to the final compression stage and diverting out of specification gas back to the beginning of the scrubbing process; and
drying cleaned biogas that meets pipeline specifications and compressing it to the pressure necessary for introduction into a tanker or a natural gas pipeline.
